(19) United States
(12) Patent Application Publication
(10) Pub. No.: US 2005/0150147 A1
(43) Pub. Date: Jul. 14, 2005

(54) Advertising display system for the sides of vehicles and methods of use thereof

(76) Inventor: John W. Berryman, Moore, OK (US)

Correspondence Address: DUNLAP, CODDING & ROGERS P.C., PO BOX 16370, OKLAHOMA CITY, OK, 73113, US

(21) Appl. No.: 10/757,224

(22) Filed: Jan. 14, 2004

(51) Int. Cl. G09F 21/04

(52) U.S. Cl. 40/590

(57) ABSTRACT

Methods of advertising more than one product on a trailer, as well as methods of using a trailer for displaying replacement advertisements, are disclosed. A series of prices are generated based on a factor for a size of a section of a portion of a sidewall or rearwall of a trailer, a factor based on the advertisement content, a factor based on an period of time that the advertisement is displayed, and a factor based on the travel path of the trailer. Once selections for each factor are made, an offer is generated and sold to a customer for advertising a product, name, graphic or logo associated with the customer. Then the offer is transmitted to a distributor for production of the advertisement and placement of the advertisement on the section of the trailer for the predetermined period of time. Two or more advertisements for two or more different customers may be produced in this manner and displayed on the sidewall or rearwall of the trailer for the same or different predetermined periods of time.

### CROSS REFERENCE TO RELATED APPLICATIONS

Not Applicable.

### STATEMENT REGARDING FEDERALLY SPONSORED RESEARCH AND DEVELOPMENT

Not Applicable.

### BACKGROUND OF THE INVENTION

1. Field of the Invention

The present invention relates generally to methods of advertising, and more specifically, to methods of advertising more than one product using advertising display systems that are releasably attached to the sides of vehicles.

2. Brief Description of the Art

Today's economy is run on the buying and selling of various products and services. In order to educate the public at large of the existence and availability of these products and services, various types of advertisements are employed. These advertisements can take many different forms or utilize a number of different media such as but not limited to newspapers, magazines, television, radio, roadside billboards and the like. The purpose of using different forms of media is to reach as many consumers as possible. Consistent with the use of roadside billboards, many advertisers are using automobiles or trucks to publicize their goods or services.

It is well known to display advertising on the exterior of personal motor vehicles such as automobiles or trucks. Typically the advertising is permanently applied to the exterior of the vehicle, such as by painting. Optionally, magnetic signs that stick to the body panels of motor vehicles are also known. However, such techniques have the disadvantage of permanently altering the exterior finish of the motor vehicle or the potential to damage the finish of the body panel to which they are applied. In addition, such methods of advertising are typically utilized by employees of the advertising company and are applied to commercial vehicles owned by and/or utilized in the service of the advertising company. Thus, this type of advertising is limited to a single advertisement for one product or company.

There is considerable interest in using the sides of semi-trailers as advertising billboards. Tens of millions of semi-trailer/tractor-trailer rigs travel the world's highways on a daily basis. Trucks can be divided into two important groups: those that are owned by transportation companies, and those that are owned by companies engaged primarily in other pursuits. Tractor-trailer rigs belonging to the former group generally provide transportation services to a constantly-varying list of customers, and each rig typically displays nothing more than the name of the trucking company. Rigs belonging to the latter group are generally used exclusively in the service of the owning company and generally display permanent, singular advertising that is painted or bonded to the trailer.

Although there is widespread recognition that tractor-trailer rigs owned by transportation companies have tremendous advertising potential, the costs involved with the application of advertising signs to the sides of trailers and their subsequent removal are a real hindrance. While painted signs are amenable for permanent advertising, for temporary advertising, the labor and talent required to paint attractive signs on the side of a truck is costly and do not even take into account the costs incurred by the trailer downtime during the painting operation. Removal of unwanted signs is also problematic, resulting in hazardous waste (and the cost associated with the disposal thereof), and also results in significant trailer downtime.

In cases where advertising is printed on a vinyl or other polymeric plastic sheet which is, in turn, adhesively applied to the sides of a truck, a high level of skill is required to correctly apply the panel without inadvertently incorporating ripples or bubbles into the surface. As with painted advertising, removal of adhesively-adhered polymeric plastic advertising sheets will result in their destruction, and removal is time-consuming and difficult.

Due to the above-described disadvantages and defects associated with the placement of temporary advertising on the sides of tractor-trailers or semi-trailers, the temporary advertisements contemplated for use on the sides of tractor-trailers or semi-trailers has continually been limited to one advertisement per tractor-trailer or semi-trailer, that is, a single advertisement is attached to a substantial portion of the side of the tractor-trailer or semi-trailer.

Thus, there is a need felt in the art for methods of using a vehicle, such as a tractor-trailer or semi-trailer, for displaying advertising for more than one product, thereby overcoming the disadvantages and defects of the prior art. It is to such methods of advertising more than one product on an exterior surface of a vehicle that the present invention is directed.

### SUMMARY OF THE INVENTION

According to the present invention, methods of advertising more than one product using advertising display systems that are detachably connected to a vehicle, such as but not limited to a trailer, are disclosed. Broadly, the advertising display system will accommodate having a plurality of advertisements affixed thereto for display on a sidewall or rearwall of the trailer for a predetermined period of time. The plurality of replaceable advertisements may be affixed to the sidewall or rearwall of the trailer at the same time or at different times, and the predetermined period of time that each of the advertisements is displayed may be the same or different.

It is an object of the present invention to provide a method for advertising more than one product on a vehicle, such as but not limited to, a trailer. The method includes providing the trailer having two sidewalls and a rearwall, and providing a first advertisement and a second advertisement. The first and second advertisements each have a front surface having product disclosure information for a product disposed thereon and a rear surface, and each of the advertisements may be detachably connected to the exterior surface of the trailer. The first advertisement is attached to one of the sidewalls or the rearwall of the trailer such that the product disclosure information for a first product is visible on the side of the trailer, and the second advertisement is attached to one of the sidewalls or the rearwall of the trailer such that the product disclosure information for a second product is visible on the trailer. The advertisements are each displayed for a predetermined period of time and then replaced by removing each of the advertisements when the predetermined period of time has passed. The predetermined period of time for displaying the two advertisements may be the same or different. In addition, the first and second advertisements may be attached to the trailer at the same time, or the first advertisement may be attached to the trailer and displayed on the trailer for a period of time prior to attaching the second advertisement to the trailer.

It is a further object of the present invention, while achieving the before-stated object, to provide a method of using a vehicle for displaying replacement advertisements. The method includes dividing at least a portion of a sidewall or a rearwall of a vehicle, such as but not limited to a trailer, into one or more sections wherein each of the one or more sections is adapted to display a replaceable advertisement and wherein the combination of the replaceable advertisement and the section of the sidewall or rearwall of the trailer is offered for sale for a predetermined period of time. A series of prices is then generated, wherein each price comprises a factor based on a size of the section, a factor based on a content of the advertisement, and a factor based on a predetermined period of time that the advertisement is displayed on the section of the sidewall or rearwall of the trailer. Each price may further include a factor based on a travel path of the trailer for the predetermined period of time. An offer is then generated for the combination of the replaceable advertisement and the section of the sidewall or rearwall of the trailer wherein the size of the section, the content of the advertisement and the predetermined period of time that the advertisement is displayed on the sidewall or rearwall of the trailer have been selected for the offer, and the offer is sold to a customer for advertising a product, name, graphic or logo associated with the customer. The offer is then transmitted to a distributor for production of the advertisement and placement of the advertisement on the section of the sidewall or rearwall of the trailer for the predetermined period of time.

Other objects, features and advantages of the present invention will become apparent from the following detailed description when read in conjunction with the accompanying drawings and appended claims.

### BRIEF DESCRIPTION OF THE DRAWINGS

FIG. 1 is a perspective view of a first sidewall of a trailer having an advertising display system disposed thereon in accordance with the present invention.

FIG. 2 is a perspective view of a second sidewall of the trailer of FIG. 1 having an identical advertising display system disposed thereon.

FIG. 3 is a perspective view of a first sidewall of a trailer having an advertising display system disposed thereon in accordance with the present invention.

FIG. 4 is a perspective view of a second sidewall of the trailer of FIG. 3 having a different advertising display system disposed thereon.

FIG. 5 is a perspective view of a first sidewall of a trailer having another embodiment of an advertising display system disposed thereon in accordance with the present invention.

FIG. 6 is a perspective view of a second sidewall of the trailer in FIG. 5.

FIG. 7 is a perspective view of another embodiment of an advertising display system disposed on a sidewall of a trailer in accordance with the present invention.

FIG. 8 is a perspective view of another embodiment of an advertising display system disposed on a sidewall of a trailer in accordance with the present invention.

FIG. 9 is a perspective view of another embodiment of an advertising display system disposed on a sidewall of a trailer in accordance with the present invention.

FIG. 10 is a perspective view of another embodiment of an advertising display system of the present invention, wherein the advertising display system is disposed on a rearwall of a trailer.

### DETAILED DESCRIPTION OF THE INVENTION

Before explaining at least one embodiment of the invention in detail by way of exemplary drawings and procedures, it is to be understood that the invention is not limited in its application to the details of construction and the arrangement of the components set forth in the following description or illustrated in the drawings. The invention is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

The present invention is directed to an advertising display system for displaying a plurality of replaceable advertisements on a sidewall or rearwall of a tractor-trailer or semi-trailer and methods of using same. Each of the plurality of replaceable advertisements are detachably affixed to the sidewall or rearwall of the trailer and are displayed for a predetermined period of time. The plurality of replaceable advertisements may be affixed to the sidewall or rearwall of the trailer at the same or different times, and the predetermined period of time that each of the advertisements is displayed may be the same or different.

The term “truck” or “trailer” as used herein will be understood to refer to trucks of all types, including but not limited to full trailers (where all of the weight is borne by a single chassis) and semi-trailers (where the weight is shared between the tractor chassis and the trailer chassis). The term “truck” or trailer” includes those vehicles where the cargo-receiving part is just a few inches behind the car or tractor as well as those vehicles where the cargo-receiving part thereof is spaced a foot or more from the tractor or cab, as in most semi-trailers.

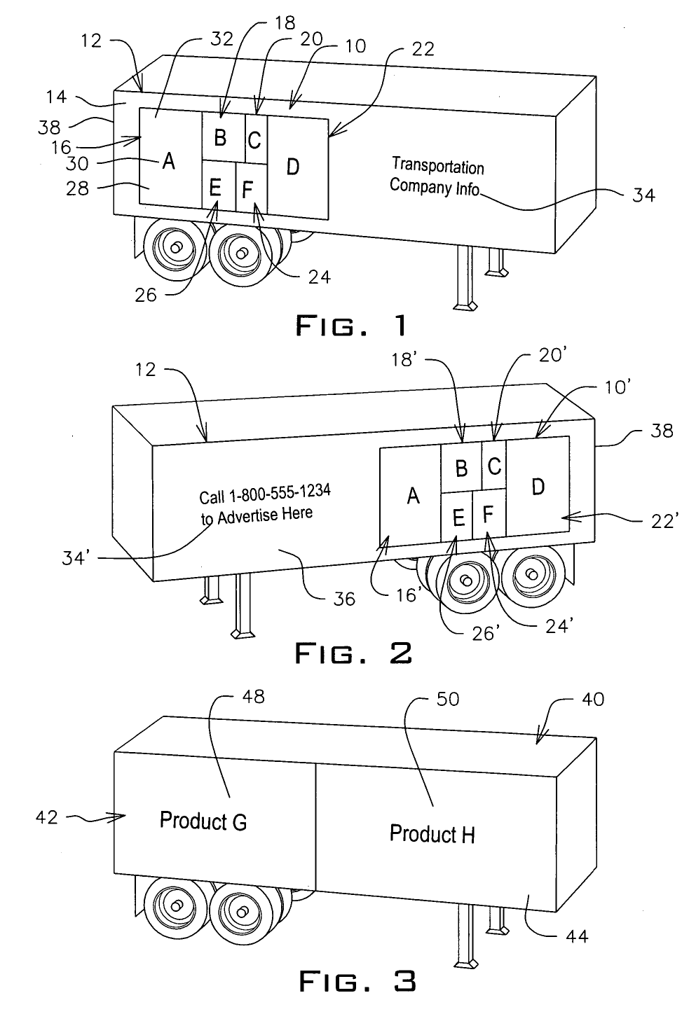

Shown in FIG. 1 is an advertising display system 10 for a trailer 12, wherein the advertising display system 10 is constructed in accordance with the present invention. The advertising display system 10 is illustrated as being disposed on a first sidewall 14 of the trailer 12 by methods known in the art and described herein after. The advertising display system 10 is preferably disposed on a portion of the trailer 12 that has a substantially flat, planar surface and is easily visible by passersby and the general public. While the advertising display system 10 is illustrated as being disposed on the first sidewall 14, it is to be understood that the advertising display system 10 can be disposed on a second sidewall 36 or a rearwall 38 of the trailer 12 (see FIG. 2).

The advertising display system 10 comprises two or more advertisements, and the advertising display system 10 is illustrated in FIG. 1 as having six advertisements, namely advertisements 16, 18, 20, 22, 24 and 26. The advertisements 16, 18, 20, 22, 24 and 26 may be advertising banners, placards, pennants or other types of signs, as long as the advertisements can be detachably connected to the first sidewall 14 of the trailer 12 and can function as described herein. Each of the advertisements 16, 18, 20, 22, 24 and 26 possess similar characteristics and function in a similar manner. Therefore, for the sake of brevity, only the features of advertisement 16 will be described in detail hereinafter; however, it is to be understood that the advertisements 18, 20, 22, 24 and 26 also possess similar characteristics and function in a similar manner as that described herein below for advertisement 16.

The advertisement 16 is provided with a front surface 28 on which product disclosure information 30 is disposed, and a rear surface 32. The advertisement 16 may be detachably connected to the first sidewall 14 of the trailer 12 via the rear surface 32 thereof. The rear surface 32 of the advertisement 16 and/or the first sidewall 14 of the trailer 12 may be provided with an attachment element thereon for detachably connecting the advertisement 16 to the trailer 12. “Attachment element” as used herein refers to any type of material or thing which can be used to effect the temporary bonding or connecting of two adjacent portions of material to effect the connection or bonding described herein and allow for temporary attachment of the advertisement 16 to the trailer 12, yet provide a connection or bonding that is sufficiently strong so as to prevent premature detachment of the advertisement 16 from the trailer 12. Examples of attachment elements that may be used in accordance with the present invention include, but are not limited to, adhesives, cohesives, magnetic materials, heat sealable materials, chemically shrinkable materials, pressure sealable materials, sonic sealable materials, vibratory sealable materials, weld sealable materials, mechanical or barb-type fastening means or clamps, clamps, ties, labels, bands, ribbons, strings, tapes, staples, and combinations thereof. Examples of assemblies for connecting single information displays or advertisements to trucks and trailers that are known in the art have been disclosed in U.S. Pat. No. 6,092,319, issued Jul. 25, 2000 to Hicks; U.S. Pat. No. 5,349,772, issued Sep. 27, 1994 to Pardue; U.S. Pat. No. 6,041,535, issued Mar. 28, 2000 to Holloway et al.; and U.S. Pat. No. 6,167,649, issued Jan. 2, 2001 to Palmeri; the contents of each of which are hereby expressly incorporated herein by reference, and such assemblies may be utilized as attachment elements in accordance with the present invention. Preferably, the attachment element is Controltac™ Plus graphic film, (3M™, St. Paul, Minn.), a removable, self adhesive material that is specifically designed for use on riveted or corrugated surfaces, and has up to two years durability. Such material provides a heretofore unknown excellent temporary seal when disposed on an exterior surface of a trailer. Preferably, the attachment element is a material that will not cause a permanent alteration to the exterior surface of the trailer.

The product disclosure information 30 provided on the front surface 28 of the advertisement 16 may be any desired content of information utilized in advertising a product, service or company associated with a customer purchasing the advertisement 16. For example but not by way of limitation, the product disclosure information 30 may be selected from the name of a product, the name of a company that produces the product, the name of the distributor that sells the product, the name of a type of service provided by the company or distributor, a logo, letters, numbers, graphics, and combinations thereof. While the advertisement 16 is described as having product disclosure information 30 thereon, it should be understood that the advertisement 16 may be provided with any desired information for conveying to the public, such as but not limited to, information related to a political or non-political group, such as but not limited to endorsements, messages, program listings, requests for donations and the like, and thus such information is also included within the definition of “product disclosure information” as used herein. In other words, the product disclosure information 30 may be any information that would be displayed on a billboard or other type of display system for exposing passers-by and the public in general to the information contained thereon.

In addition, the product disclosure information 30 may be related to a particular time of year or season, depending on the time of year that the advertisement 16 is displayed and the predetermined period of time that the advertisement 16 continues to be displayed. For example, seasonable product disclosure information 30 includes, but is not limited to, displaying harvest, Halloween, Thanksgiving or Christmas ads or information during the fall and winter months, displaying springtime or Easter ads or information during the spring months, and displaying closeout or outdoor ads or information during the summer months.

As shown in FIG. 1, the advertising display system 10 may cover only a portion of the sidewall 14 of the trailer 12, and this will leave additional space on the sidewall 14 for other information 34 to be displayed on the remaining portion of the sidewall 14 of the trailer 12, if desired. Such information 34 includes, but is not limited to, information concerning the transportation company that owns the trailer 12, information pertaining to the contents of the trailer 12 that are being transported, or contact information on how to display an advertisement on the advertising display system 10.

While the first sidewall 14 of the trailer 12 is depicted as having advertising display system 10 disposed thereon, the corresponding second sidewall 36 of the trailer 12 may have a similar or identical advertising display system 10′ disposed thereon, as illustrated in FIG. 2. The advertising display system 10′ is illustrated as being identical to the advertising display system 10 and has advertisements 16′, 18′, 20′, 22′, 24′ and 26′ disposed thereon. Optionally, the second sidewall 36 of the trailer 12 may have a different advertising display system disposed thereon, or may not have any advertising display system disposed thereon, as will be described in more detail herein below.

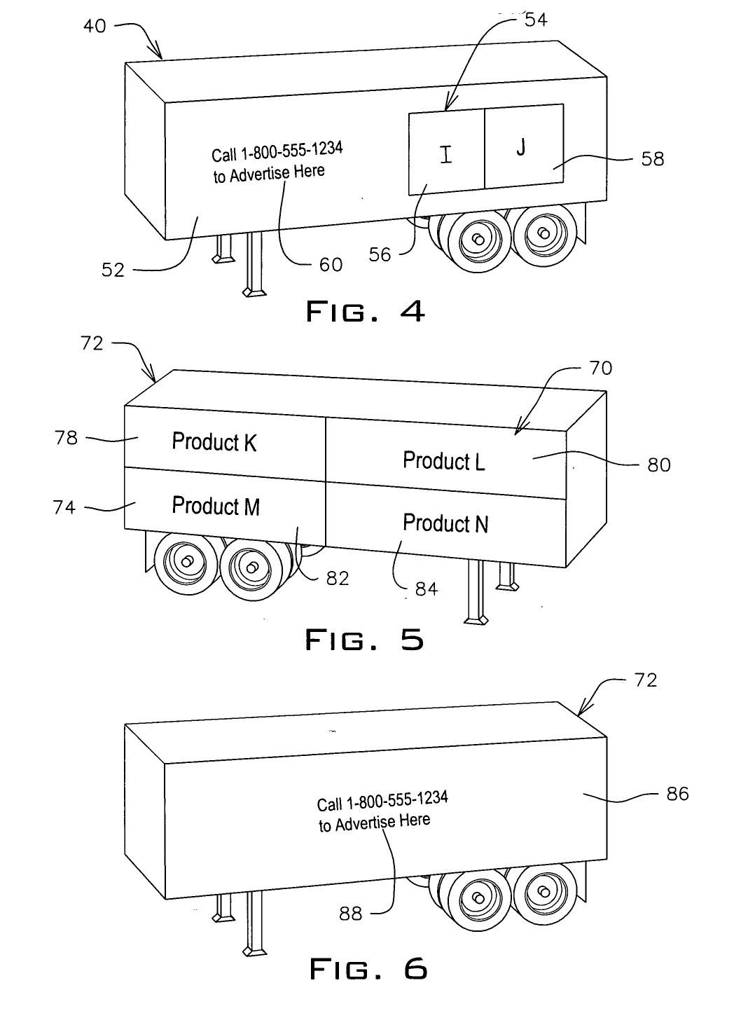

Shown in FIG. 3 is a trailer 40 having an advertising display system 42 similar to the advertising display system 10 described herein above disposed on a first sidewall 44 of the trailer 40. The advertising display system 42 comprises two advertisements 48 and 50, each of which comprise substantially one-half of the first sidewall 44 of the trailer 40, and therefore the advertising display system 10 substantially covers the entire first sidewall 44 of the trailer 40. A second sidewall 52 of the trailer 40, as shown in FIG. 4, comprises another advertising display system 54, and the advertising display system only covers a portion of the second sidewall 52 of the trailer 40. The advertising display system 54 comprises advertisements 56 and 58, and the advertisements 56 and 58 may contain the same product disclosure information as advertisements 48 and 50 disposed on the first sidewall 44 of the trailer 40, or the advertisements 56 and 58 may be different from the advertisements 48 and 50. Since the advertising display system 42 only covers a portion of the second sidewall 52 of the trailer 40, the remaining portion of the second sidewall 52 of the trailer 40 may display other information 60, such as but not limited to, information concerning the transportation company that owns the trailer 40, information pertaining to the contents of the trailer 40 that are being transported, contact information on how to display an advertisement on the advertising display system 42, and the like. In addition, while the other information 60 is shown as being disposed on a remaining portion of the sidewall 52 of the trailer 40 that does not contain an advertising display system, it is to be understood that this type of information may also be included in the advertising display systems described herein.

Shown in FIG. 5 is another configuration of advertising display system 70 for a trailer 72 that is disposed on a first sidewall 74 of the trailer 72. The advertising display system 70 comprises four advertisements 78, 80, 82 and 84, each of which comprise substantially one-fourth of the first sidewall 74 of the trailer 72, and therefore the advertising display system 70 substantially covers the entire first sidewall 74 of the trailer 72. A second sidewall 86 of the trailer 72, as shown in FIG. 6, does not contain an advertising display system. The second sidewall 86 of the trailer 72 may contain other information 88 such as but not limited to, information concerning the transportation company that owns the trailer 72, information pertaining to the contents of the trailer 72 that are being transported, contact information on how to display an advertisement on the advertising display system 70, and the like. Optionally, the second sidewall 86 of the trailer 72 will be free of advertising display systems and other information.

Shown in FIGS. 7-9 are other configurations of advertising display systems that are encompassed by the present invention. FIG. 7 illustrates a trailer 90 having an advertising display system 92 disposed on a sidewall 94 thereof, wherein the advertising display system 92 substantially covers the entire sidewall 94 of the trailer 90. The advertising display system 92 comprises four advertisements, 96, 98, 100 and 102.

In FIG. 8, a trailer 110 is depicted as having an advertising display system 112 disposed thereon, wherein the advertising display system only covers a portion of a sidewall 114 of the trailer 110, and the advertising display system 112 comprises two advertisements, 116 and 118. This is in contrast to the advertising display system 42 of FIG. 3, which also contained two advertisements but which substantially covered the entire first sidewall 44 of the trailer 40.

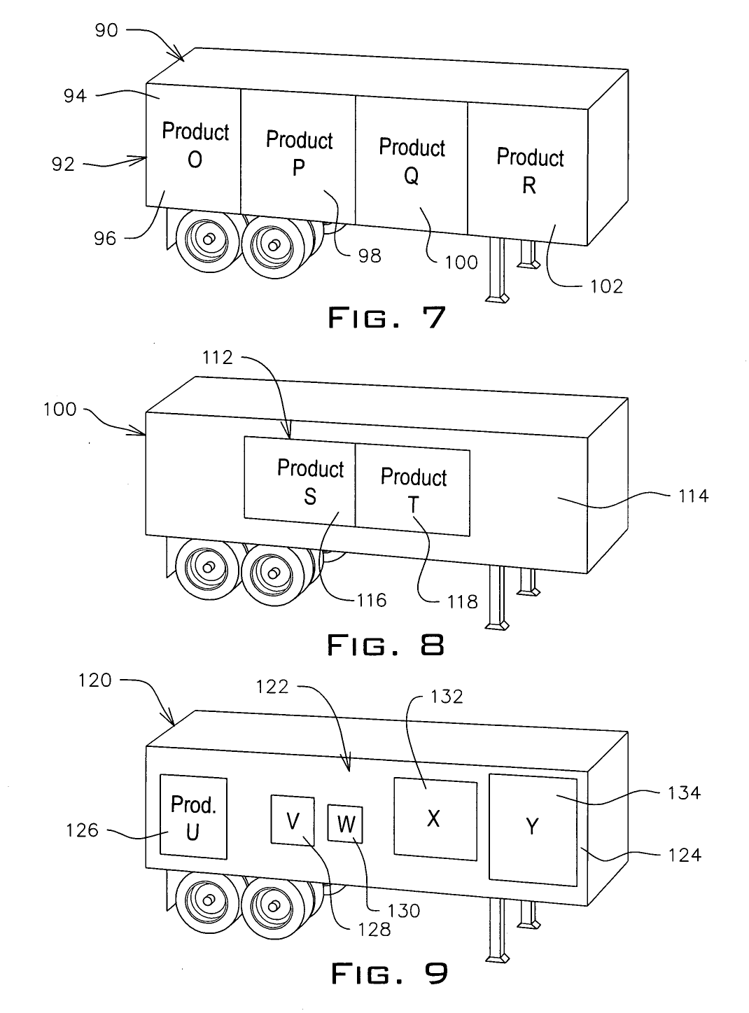

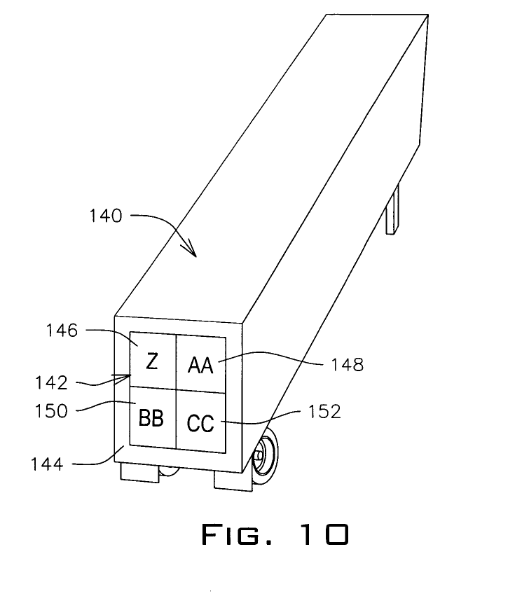

In FIG. 9, a trailer 120 having an advertising display system 122 disposed on a sidewall 124 thereof is illustrated. The advertising display system 122 comprises five advertisements, 126, 128, 130, 132 and 134. Unlike the configurations of advertising display systems shown and described herein before, the advertising display system 122 is disposed on the sidewall 124 of the trailer 120 in such a manner that the advertisements 126, 128, 130, 132 and 134 do not come into contact but rather are spaced at various intervals across the sidewall 124 of the trailer 120.

While several configurations and sizes of advertising display systems and advertisements have been illustrated and described herein, it is to be understood that any configuration and size of advertising display system and advertisements are contemplated within the scope of the present invention, and thus the present invention is not limited to the configurations and sizes shown and described herein. In addition, while certain combinations of advertising display systems and/or other information have been illustrated on two sidewalls of a trailer, it is to be understood that the invention is not limited to these particular combinations, and that a trailer having an advertising display system disposed on a first sidewall thereof may be provided with any of the combinations described herein, or nothing at all, disposed on a second sidewall thereof.

In addition, an advertising display system may be disposed on a rearwall of a trailer, either alone or in combination with any of the advertising display systems described herein above in relation to FIGS. 1-9. FIG. 10 illustrates a trailer 140 having an advertising display system 142 disposed on a rearwall 144 of the trailer 140. The advertising display system 142 as shown as including four advertisements, 146, 148, 150 and 152. The sidewalls of the trailer 140 may be void of any information thereon, or the sidewalls of the trailer 140 may have information disposed thereon, such as but not limited to, information concerning the transportation company that owns the trailer 140, information pertaining to the contents of the trailer 140 that are being transported, contact information on how to display an advertisement on the advertising display system 142, and the like. In a further alternative, one or both of the sidewalls of the trailer 140 may be provided with an advertising display system disposed thereon, wherein the advertising display system may be the same or different from the advertising display system 142.

Further, while the advertising display systems and methods of the present invention are described herein for use with a trailer, it is to be understood that the advertising systems and methods of the present invention are also amenable for use with other vehicles, such as but not limited to, cars, vans, trucks, sport utility vehicles, buses, city vehicles of all types, state vehicles of all types, and the like. Therefore, the application of advertising display systems and methods described herein to any vehicle falls within the scope of the present invention.

The present invention is also directed to a method of using the advertising display system described herein above. For the sake of brevity, the advertising display system 10 will be described in further detail herein below. However, it is to be understood that the advertising display systems 42, 54, 70, 92, 112 and 122 will also function in a similar manner as that described herein below.

In the method of the present invention, the trailer 12 is provided, and at least one of the advertisements 16, 18, 20, 22, 24 and 26, is attached to the first sidewall 14 thereof. The at least one of advertisements 16, 18, 20, 22, 24 and 26 is then displayed for a predetermined period of time and then replaced when desired by removing the at least one of advertisements 16, 18, 20, 22, 24 and 26 from the first sidewall 14 of the trailer 12.

For example, and as illustrated more clearly in Table I below, the advertisement 16 may be attached to the first sidewall 14 of the trailer 12 at time point 0 days, and the advertisement 16 may be displayed for a time period of 60 days. At time point 15 days, advertisement 18 may be attached to the first sidewall 14 of the trailer 12 and displayed for a time period of 90 days. Also at time point 15 days, advertisement 20 may be attached to the first sidewall 14 of the trailer 12 and displayed for a time period of 45 days. At time point 30 days, advertisement 22 may be attached to the first sidewall 14 of the trailer 12 and displayed for a time period of 60 days. Also at time point 30 days, advertisement 24 may be attached to the first sidewall 14 of the trailer 12 and displayed for a time period of 30 days. At time point 60 days, advertisement 26 may be attached to the first sidewall 14 of the trailer 12 and displayed for a time period of 30 days. Also at time point 60 days, advertisements 16, 20 and 24 will be removed from the first sidewall 14 of the trailer 12, and at such point a new advertisement may be placed in the positions occupied by any of advertisements 16, 20 and 24, and a new time period for display set for such advertisements. At time point 90 days, advertisements 22 and 26 will be removed from the first sidewall 14 of the trailer 12, and at time point 105 days, advertisement 18 will be removed from the first sidewall 14 of the trailer 12. Upon removal of any of the advertisements from the first sidewall 14 of the trailer 12, a new advertisement may be placed in the position occupied by that advertisement. Optionally, the space that the advertisement occupied in the advertising display system 10 may be left blank. In a further alternative, the advertiser may choose to display any of the advertisements for a period of time beyond that originally chosen, and the advertisement will remain in place as long as payment is made for the additional period of time that the advertisement is displayed.

TABLE I

| Advertisement | Attached at: | Display for: | Remove at: |
|---|---|---|---|
| 16 | 0 | 60 | 60 |
| 18 | 15 | 90 | 105 |
| 20 | 15 | 45 | 60 |
| 22 | 30 | 60 | 90 |
| 24 | 30 | 30 | 60 |
| 26 | 60 | 30 | 90 |

| | |
|---|---|
| At Day 15, the advertisements are: | 16, 18, 20 |
| At Day 30, the advertisements are: | 16, 18, 20, 22 and 24 |
| At Day 60, the advertisements are: | 18, 22 and 26 |

The present invention is also related to a method of using a trailer for displaying replacement advertisements. In the method, a person who owns a trailer, such as but not limited to an owner of a transportation company, or a person authorized by the owner of the trailer, such as but not limited to an employee of the transportation company, an independent contractor or an employee of advertising agency, divides at least a portion of an exterior surface (such as a sidewall or a rearwall) of the trailer into two or more sections wherein each of the sections is adapted for display of a replaceable advertisement. This is performed in a manner much like that shown in FIGS. 1-9. The combination of the replaceable advertisement and the section of the sidewall or rearwall of the trailer can then be offered for sale/lease for a predetermined period of time.

A series of prices is generated wherein each price comprises at least one of a factor based on a size of the section of the sidewall or rearwall of the trailer, a factor based on a content of the advertisement, a factor based on a predetermined period of time that the advertisement is displayed on the section of the sidewall or rearwall of the trailer, and a factor based on a travel path of the trailer for the predetermined period of time.

The size of the section may be any size that is large enough for the advertisement disposed thereon to be visible to the general public and/or a passerby, yet less than an entire side of a trailer. Generally, the factor for the size of the section will increase as the size of the section increases, as the advertisement attached to the section increases in size as the size of the section increases, and the number of other advertisements present on the side of the trailer decreases as the size of the section increases. Examples of section sizes that may be used in accordance with the present invention include, but are not limited to, about 2′×2′, about 2′×4′, about 4′×2′, about 4′×6′, about 6′×4′, about 4′×8′, about 8′×4′, about 8′×8′, about 8′×10′, about 10′×8′, about 8′×12′, about 12′×8′ and the like. In addition, the size of the section may be provided as a fraction of the side of the trailer rather than by length and width. Examples of such sizes of sections include, but are not limited to, about one-half, about one-fourth, about one-sixth, about one-eighth, about one-tenth, about one-twelfth, about one-fifteenth, about one-sixteenth, about one-twentieth, about one-twenty-fifth, and the like. In addition, most trailers generally contain panels that have dimensions of about 4′×8′. The size of the section may also be stated in number of panels, such as but not limited to, about one panel, about two panels, about three panels, and the like.

The predetermined period of time that an advertisement is displayed on the trailer will vary, generally depending upon how often the distributor desires to change advertisements on the trailer. Examples of periods of time that may be used in accordance with the present invention include, but are not limited to, 30 days, 45 days, 60 days, 90 days, 120 days, 150 days, 180 days, 210 days, 240 days, 270 days, and the like.

The series of prices may each also contain a factor based on a travel path of the trailer for the predetermined period of time. The travel path may be a local travel path, a regional travel path or a national travel path. Generally, the larger the travel path, and thus the more area covered by the trailer, the higher the factor based on the travel path. This factor may also be used to determine on which trailer to advertise. For example, it would not be desirous to place an advertisement for a local store on a trailer that will have a national travel path.

Finally, the series of prices may also contain a factor based on the content of the advertisement. The content of the advertisement, as defined herein, may be selected from any of the materials described herein above as “product disclosure information”.

Based on the factors described hereinabove, the series of prices generated may be compiled into a table or chart that easily displays the pricing differentials for different combinations of sizes of the section, contents of the advertisement, predetermined periods of time that the advertisement is to be displayed and/or travel paths of the trailer. Once a selection for each factor has been made the factors are then calculated to provide a price for the combination of factors so that an offer may be generated.

Once these factors have been selected, an offer is generated for the combination of the replaceable advertisement and the section of the sidewall or rearwall of the trailer wherein the factors based on size of the section, content of the advertisement, predetermined period of time that the advertisement is to be displayed and/or travel path of the trailer are included in the offer. The offer is then sold to a customer for advertising a product, name, graphic, service or logo associated with the customer.

The offer is then transmitted to a distributor for production of the advertisement and placement of the advertisement on the section of the sidewall or rearwall of the trailer for the predetermined period of time. The term “distributor” as used herein may refer to a single individual or more than one individual. That is, the advertisement may be produced by one individual and provided to a second individual for placement on the section of the sidewall or rearwall of the trailer, or a single individual may both produce the advertisement and place the advertisement on the section of the sidewall or rearwall of the trailer. The “distributor” may include the person who owns the trailer, such as but not limited to an owner of a transportation company, or a person authorized by the owner of the trailer, such as but not limited to an employee of the transportation company, an independent contractor, an employee of an advertising agency, or another individual with whom the owner of the trailer has established a working relationship.

When the distributor is not the owner of the trailer utilized in the method of the present invention, the distributor transmits a portion of the offer to the owner of the trailer. In this manner, the method of the present invention is advantageous to all parties involved.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

1. A method of advertising more than one product on a trailer, the method comprising the steps of:
providing a trailer having a first sidewall, a second sidewall and a rearwall;
providing a first advertisement, the first advertisement having a front surface having product disclosure information for a first product disposed thereon and a rear surface, wherein the first advertisement may be detachably connected to the trailer;
providing a second advertisement, the second advertisement having a front surface having product disclosure information for a second product disposed thereon and a rear surface, wherein the second advertisement may be detachably connected to the trailer;
attaching the first advertisement to one of the first sidewall, the second sidewall and the rearwall of the trailer wherein the product disclosure information for the first product is visible on the first sidewall, second sidewall or rearwall of the trailer;
attaching the second advertisement to the sidewall or rearwall of the trailer to which the first advertisement is attached, wherein the product disclosure information for the second product is visible on the first sidewall, second sidewall or rearwall of the trailer;
displaying the first advertisement for a predetermined period of time;
displaying the second advertisement for a predetermined period of time;
removing the first advertisement from the sidewall or rearwall of the trailer once the predetermined period of time has passed; and
removing the second advertisement from the sidewall or rearwall of the trailer once the predetermined period of time has passed.

2. The method of claim 1 wherein, in the steps of providing first and second advertisements, the product disclosure information for the first and second products are selected from the group consisting of the name of the product, the name of the company that produces the product, the name of the distributor that sells the product, the name of a type of service provided by the company or distributor, a logo, letters, numbers, graphics, and combinations thereof.

3. The method of claim 1 wherein, in the steps of attaching the first and second advertisements to one of the first sidewall, the second sidewall and the rearwall of the trailer, an attachment element is provided on at least one of the rear surface of the first or second advertisement and the sidewall or rearwall of the trailer to which the first and second advertisements is attached, and wherein the attachment element is selected from the group consisting of adhesives, cohesives, magnetic materials, heat sealable materials, chemically shrinkable materials, pressure sealable materials, sonic sealable materials, vibratory sealable materials, weld sealable materials, mechanical or barb-type fastening means or clamps, clamps, ties, labels, bands, ribbons, strings, tapes, staples, and combinations thereof.

4. The method of claim 1 wherein the first advertisement and the second advertisement are replaced at the same time.

5. The method of claim 1 wherein the first advertisement is replaced prior to replacing the second advertisement.

6. The method of claim 1 wherein the method further comprises the step of producing the first and second advertisements.

7. The method of claim 1 wherein, in the step of providing a trailer, the trailer is selected from the group consisting of a semi-trailer and a tractor-trailer.

8. A method of using a trailer for displaying replacement advertisements, comprising the steps of:
dividing at least a portion of one of a first sidewall, a second sidewall and a rearwall of a trailer into two or more sections wherein each of the two or more sections is adapted to display a replaceable advertisement and wherein the combination of the replaceable advertisement and the section of the sidewall or rearwall of the trailer is offered for sale for a predetermined period of time;
generating a series of prices wherein each price comprises:
a factor based on a size of the section, and
a factor based on a predetermined period of time that the advertisement is displayed on the section of the sidewall or rearwall of the trailer;
generating an offer for the combination of the replaceable advertisement and the section of the sidewall or rearwall of the trailer wherein the size of the section, the content of the advertisement and the predetermined period of time that the advertisement is displayed on the section of the rearwall of the trailer have been selected for the offer;
selling the offer to a customer for advertising a product, name, graphic, service or logo associated with the customer; and
transmitting the offer to a distributor for production of the advertisement and placement of the advertisement on the section of the sidewall or rearwall of the trailer for the predetermined period of time.

9. The method of claim 8 wherein, in the step of generating a series of prices, the size of the section is selected from the group consisting of about 2′×2′, about 2′×4′, about 4′×2′, about 4′×6′, about 6′×4′, about 4′×8′, about 8′×4′, about 8′×8′, about 8′×10′, about 10′×8′, about 8′×12′ and about 12′×8′.

10. The method of claim 8 wherein, in the step of generating a series of prices, the predetermined period of time is selected from the group consisting of 30 days, 45 days, 60 days, 90 days, 120 days, 150 days, 180 days, 210 days, 240 days and 270 days.

11. The method of claim 8 wherein, in the step of generating a series of prices, each of the prices further comprises a factor based on a travel path of the trailer for the predetermined period of time.

12. The method of claim 11 wherein the travel path is selected from the group consisting of a local travel path, a regional travel path and a national travel path.

13. The method of claim 8 wherein, in the step of dividing at least a portion of one of a first sidewall, a second sidewall and a rearwall of a trailer into two or more sections, the trailer is selected from the group consisting of a semi-trailer and a tractor-trailer.

14. The method of claim 8 further comprising the step of transmitting a portion of the offer from the distributor to an owner of the trailer.

15. A method of using a trailer for displaying replacement advertisements, comprising the steps of:
dividing at least a portion of one of a first sidewall, a second sidewall and a rearwall of a trailer into two or more sections wherein each of the two or more sections is adapted to display a replaceable advertisement and wherein the combination of the replaceable advertisement and the section of the sidewall or rearwall of the trailer is offered for sale for a predetermined period of time;
generating a series of prices wherein each price comprises:
a factor based on a size of the section, and
a factor based on a predetermined period of time that the advertisement is displayed on the section of the sidewall or rearwall of the trailer, and
a factor based on a travel path of the trailer for the predetermined period of time;
generating an offer for the combination of the replaceable advertisement and the section of the sidewall or rearwall of the trailer wherein the size of the section, the content of the advertisement and the predetermined period of time that the advertisement is displayed on the section of the sidewall or rearwall of the trailer have been selected for the offer;
selling the offer to a customer for advertising a product, name, graphic, service or logo associated with the customer; and
transmitting the offer to a distributor for production of the advertisement and placement of the advertisement on the section of the sidewall or rearwall of the trailer for the predetermined period of time.

16. The method of claim 15 wherein, in the step of generating a series of prices, the size of the section is selected from the group consisting of about 2′×2′, about 2′×4′, about 4′×2′, about 4′×6′, about 6′×4′, about 4′×8′, about 8′×4′, about 8′×8′, about 8′×10′, about 10′×8′, about 8′×12′ and about 12′×8′.

17. The method of claim 15 wherein, in the step of generating a series of prices, the predetermined period of time is selected from the group consisting of 30 days, 45 days, 60 days, 90 days, 120 days, 150 days, 180 days, 210 days, 240 days and 270 days.

18. The method of claim 15 wherein the travel path is selected from the group consisting of a local travel path, a regional travel path and a national travel path.

19. The method of claim 15 wherein, in the step of dividing at least a portion of one of a first sidewall, a second sidewall and a rearwall of a trailer into two or more sections, the trailer is selected from the group consisting of a semi-trailer and a tractor-trailer.

20. The method of claim 15 further comprising the step of transmitting a portion of the offer from the distributor to an owner of the trailer.

21. A method of advertising more than one product on a vehicle, the method comprising the steps of:
providing a vehicle having a first sidewall, a second sidewall and a rearwall;
providing a first advertisement, the first advertisement having a front surface having product disclosure information for a first product disposed thereon and a rear surface, wherein the first advertisement may be detachably connected to the vehicle;
providing a second advertisement, the second advertisement having a front surface having product disclosure information for a second product disposed thereon and a rear surface, wherein the second advertisement may be detachably connected to the vehicle;
attaching the first advertisement to one of the first sidewall, the second sidewall and the rearwall of the vehicle wherein the product disclosure information for the first product is visible on the first sidewall, second sidewall or rearwall of the vehicle;
attaching the second advertisement to the sidewall or rearwall of the vehicle to which the first advertisement is attached, wherein the product disclosure information for the second product is visible on the first sidewall, second sidewall or rearwall of the vehicle;
displaying the first advertisement for a predetermined period of time;
displaying the second advertisement for a predetermined period of time;
removing the first advertisement from the sidewall or rearwall of the vehicle once the predetermined period of time has passed; and
removing the second advertisement from the sidewall or rearwall of the vehicle once the predetermined period of time has passed.

22. The method of claim 21 wherein, in the step of providing a vehicle, the vehicle is selected from the group consisting of a car, sport utility vehicle, bus, van, and truck.

23. A method of using a vehicle for displaying replacement advertisements, comprising the steps of:
dividing at least a portion of one of a first sidewall, a second sidewall and a rearwall of a vehicle into two or more sections wherein each of the two or more sections is adapted to display a replaceable advertisement and wherein the combination of the replaceable advertisement and the section of the sidewall or rearwall of the vehicle is offered for sale for a predetermined period of time;
generating a series of prices wherein each price comprises:
a factor based on a size of the section, and
a factor based on a predetermined period of time that the advertisement is displayed on the section of the sidewall or rearwall of the vehicle;
generating an offer for the combination of the replaceable advertisement and the section of the sidewall or rearwall of the vehicle wherein the size of the section the content of the advertisement and the predetermined period of time that the advertisement is displayed on the section of the rearwall of the vehicle have been selected for the offer;
selling the offer to a customer for advertising a product, name, graphic, service or logo associated with the customer; and
transmitting the offer to a distributor for production of the advertisement and placement of the advertisement on the section of the sidewall or rearwall of the vehicle for the predetermined period of time.

24. The method of claim 23 wherein, in the step of providing a vehicle, the vehicle is selected from the group consisting of a car, sport utility vehicle, bus, van, and truck.
